(19) United States
(12) Patent Application Publication
(10) Pub. No.: US 2024/0157460 A1
(43) Pub. Date: May 16, 2024

(54) DRAWN ARC WELDING SYSTEMS AND METHODS

(71) Applicant: Brand Shared Services LLC, Atlanta, GA (US)

(72) Inventors: Eduardo Fernando D'ORACIO DE ALMEIDA, League City, TX (US); Amrith Singh THAKUR, Houston, TX (US); Diego Arturo EDWARDS SORDO, Houston, TX (US); Lance Edward ZIER, Houston, TX (US); James EGGER, Houston, TX (US)

(73) Assignee: Brand Shared Services LLC, Atlanta, GA (US)

(21) Appl. No.: 18/510,378

(22) Filed: Nov. 15, 2023

Related U.S. Application Data
(60) Provisional application No. 63/425,488, filed on Nov. 15, 2022.

(51) Int. Cl. B23K 9/20; B23K 9/095; B23K 37/02

(52) U.S. Cl. CPC B23K 9/205; B23K 9/0953; B23K 37/0211

(57) ABSTRACT

A drawn arc welding system includes a weld gun having a stepper motor, a power inverter module configured to receive a single-phase power input and output welding power to the weld gun, and a control module having a stepper motor driver, a user interface, and a controller in communication with the stepper motor driver, the user interface, and the power inverter module. The controller is configured to receive a current for the welding power from the user interface, and instruct the power inverter module to output the current to the weld gun.

### CROSS-REFERENCE TO RELATED PATENT APPLICATIONS

This application claims the benefit of and priority to U.S. Provisional Application No. 63/425,488, filed on Nov. 15, 2022, the entire disclosure of which is hereby incorporated by reference herein.

### BACKGROUND

Drawn arc welding typically uses a welding current, supplied by a power supply, to weld a stud to a base material.

### SUMMARY

At least one embodiment relates to a drawn arc welding system. The drawn arc welding system includes a weld gun having a stepper motor, a power inverter module configured to receive a single-phase power input and output welding power to the weld gun, and a control module having a stepper motor driver, a user interface, and a controller in communication with the stepper motor driver, the user interface, and the power inverter module. The single-phase power input includes an input current of less than or equal to about 20 A. The controller is configured to receive a current for the welding power from the user interface, and instruct the power inverter module to output the current to the weld gun.

Another embodiment relates to a drawn arc welding system. The drawn arc welding system includes a weld gun having a stepper motor and a trigger, a power inverter module including a rectifier and a capacitor, and a control module including a stepper motor driver, a user interface, and a controller in communication with the weld gun, the stepper motor driver, the user interface, and the power inverter module. The power inverter module is configured to receive input power from an input power source. The input power source is a single-phase alternating-current power source or a battery. The controller is configured to receive an output current from the user interface, instruct, in response to activation of the trigger, the power inverter module to supply the output current to the weld gun to perform a weld, monitor, during the weld, the output current supplied by the power inverter module to the weld gun, and stop the power inverter module from supplying the output current to the weld gun in response to determining that the output current is outside of a current tolerance range.

Another embodiment relates to a method for operating a drawn arc welding system. The method includes receiving, at a power inverter module, single-phase input power with an input current of less than or equal to about 20 A, detecting a trigger activation from a weld gun, supplying, from the power inverter module, welding power with an output current of less than or equal to about 550 A to the weld gun, measuring the output current to collect a plurality of measured current values, averaging the plurality of measured current values to generate an average output current value, and stopping the power inverter module from supplying the output current if one of the plurality of measured current values is greater than or less than a current tolerance from the average output current value.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic illustration of a drawn arc welding system, according to an exemplary embodiment;

FIG. 2 is a schematic illustration of a power inverter module of the drawn arc welding system of FIG. 1;

FIG. 3 is a schematic illustration of a control module of the drawn arc welding system of FIG. 1;

FIG. 4 is a schematic illustration of a weld gun of the drawn arc welding system of FIG. 1;

FIG. 5 is a schematic illustration of a controller of the control module of FIG. 3; and

FIG. 6 is a flowchart illustrating a method for operating a drawn arc welding system.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The present disclosure relates to drawn arc welding systems and methods. For example, a drawn arc welding system according to the present disclosure includes a power inverter module that is configured to receive single-phase input power (e.g., at 120 Volts (V) or 240V) and provide welding power to a stepper-motor weld gun. In general, the power inverter module includes one or more power electronic components that rectify and/or invert the single-phase input power and provide welding power sufficient to enable drawn arc welding of a stud at welding distances (e.g., a distance between the power inverter module and the stepper-motor weld gun) that cannot be achieved using conventional welding systems (e.g., a welding distance of at least about 50 feet (ft), or at least about 100 ft, or at least about 150 ft). For example, conventional welding system may require three-phase power and/or a weld gun that does not include a stepper motor to achieve the welding distances enabled by the drawn arc welding system of the present disclosure.

In addition to the power inverter module, the drawn arc welding system includes a control module that is in communication with both the power inverter module and the weld gun. The control module is configured to control the welding parameters (e.g., a lift value, a plunge value, a lift velocity, a plunge velocity, a weld time, an output current) supplied to the stepper-motor weld gun and monitor the power inverter module (e.g., output current) to ensure that weld quality is maintained throughout the welding process. In general, the use of a stepper-motor weld gun provides superior control over weld quality, when compared to conventional weld guns that do not include stepper-motor control. As such, the drawn arc welding system of the present disclosure provides the advantages of superior weld control and quality provided by a stepper-motor weld gun and the ability to operate on a single-phase input power gun, which allows the system to operate in locations without three-phase power.

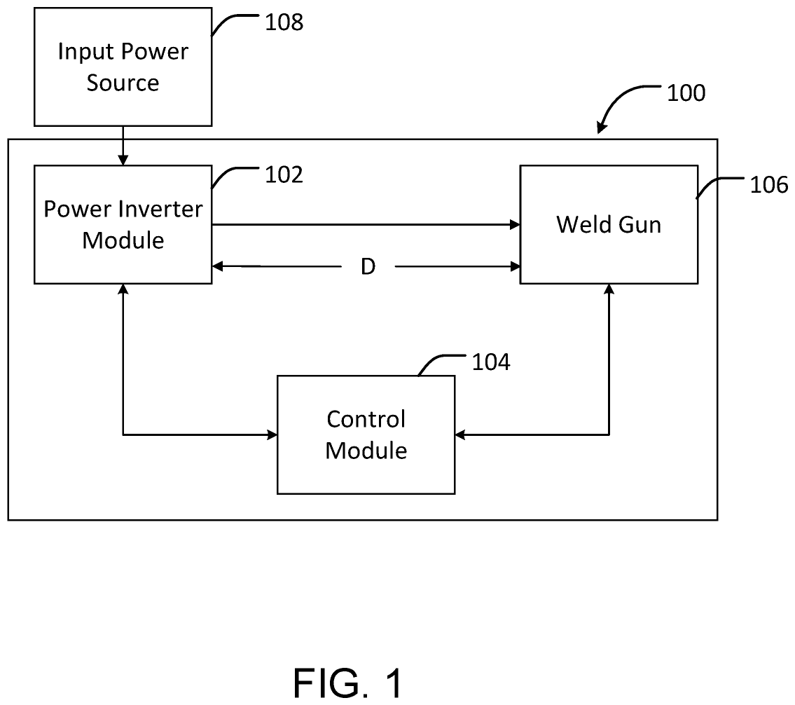

FIG. 1 illustrates a drawn arc welding system 100 according to an exemplary embodiment. The drawn arc welding system 100 includes a power inverter module 102, a control module 104, and a weld gun 106. The power inverter module 102 is configured to receive input power from an input power source 108 and supply an output power or welding power to the weld gun 106. In general, the input power source 108 is a single-phase alternating-current power source or a battery. For example, the power inverter module 102 is configured to receive a single-phase power input that includes an input current (e.g., alternative current (AC)) of less than or equal to about 20 amperes (A). In some embodiments, the single-phase power input includes an AC input of less than or equal to about 20 A at about 120V. In some embodiments, the single-phase power input includes an AC input of less than or equal to about 16 A at about 240V. In some embodiments, the input power source 108 is battery with an output voltage between about 40V and about 100V. The ability of the power inverter module 102 to receive a single-phase power input or a battery power input enables the drawn arc welding system 100 to be operated at locations without three-phase power. In other words, the power inverter module 102 does not require three-phase power to perform welding operations and control of the weld gun 106.

In some embodiments, the power inverter module 102 is configured to output the welding power with an output current that is between about 25 A and about 550 A. In some embodiments, the output current is less than or equal to about 550 A. In some embodiments, the power inverter module 102 is configured to output the welding power with the output current that is between less than or equal to about 550 A at about 40V. In some embodiments, the power inverter module 102 is configured to output the welding power at less than or equal to 22 kilowatts (kW). In some embodiments, the power inverter module 102 is configured to output the welding power between about 1 kW and about 22 kW.

The design and properties of the power inverter module 102 and the control module 104 enable the drawn arc welding system 100 to provide welding operations at a welding distance D of at least about 50 ft, or at least about 100 ft, or at least about 150 ft without a significant reduction in weld quality. In some embodiments, the weld distance D is defined between the power inverter module 102 and the weld gun 106 (e.g., a length of cable extending between the power inverter module 102 and the weld gun 106). In some embodiments, the power inverter module 102 and the control module 104 provide welding operation to the weld gun 106 of at least 6 welds per minute at a welding distance of about 150 ft.

The control module 104 is in communication (e.g., electrical communication) with the power inverter module 102 and the weld gun 106. In general, the control module 104 is configured to instruct the power inverter module 102 to provide the welding power to the weld gun 106 or stop the power inverter module 102 from providing the welding power to the weld gun 106. For example, the control module 104 is configured to instruct the power inverter module 102 to supply the output current to the weld gun 106 and monitor the output current to determine when to stop the power inverter module 102 from supplying the output current to the weld gun 106 (e.g., in response to determining that the output current is outside of a current tolerance or a weld time is expired).

The control module 104 is also configured to control operations of the weld gun 106. As described herein, the weld gun 106 includes a stepper motor that precisely controls welding operation and provides improved weld quality, when compared to weld guns without a stepper motor. In some embodiments, the control module 104 is configured to receive weld parameters from a user interface (e.g., human-machine interface (HMI)) and control the weld gun 106 according to the weld parameters input to the user interface.

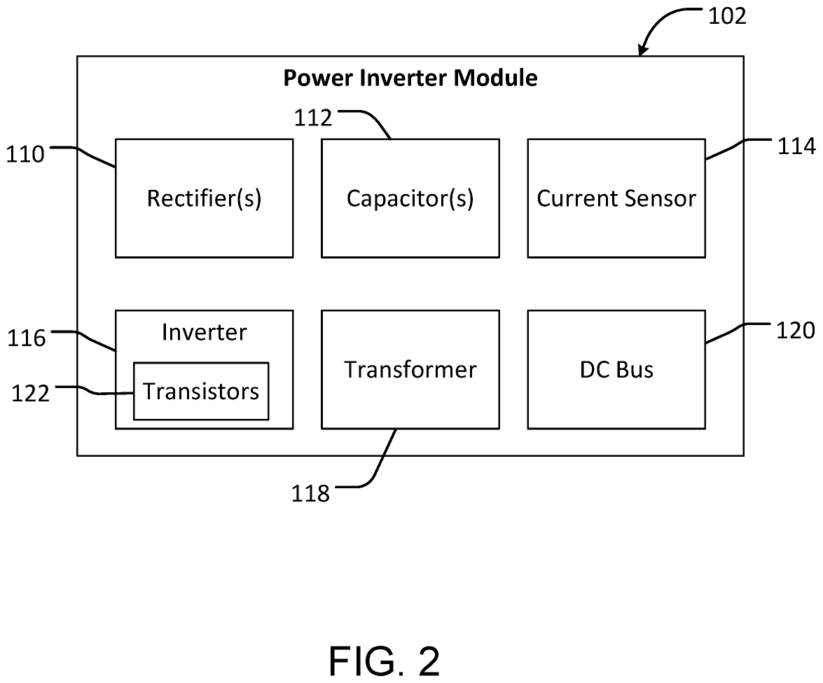

With reference to FIG. 2, the power inverter module 102 includes one or more rectifiers 110, one or more capacitors 112, a current sensor 114, an inverter 116, a transformer 118, and a direct current (DC) bus 120. In general, the power inverter module 102 is configured to receive the single-phase power input or the battery power input and output the welding power after passing the power input through the one or more power electronic components within the power inverter module. When the single-phase power input is provided to the power inverter module 102, the AC input power is rectified to DC input power with a first rectifier of the one or more rectifiers 110. The rectified DC input power is stored by the one or more capacitors 112. For example, the one or more capacitors may be in the form of a capacitor bank.

The one or more capacitors 112 are in electrically coupled to the DC bus 120. In some embodiments, the control module 104 is electrically coupled to the DC bus 120 and configured to receive DC power from the DC bus 120. In other words, the control module 104 may be powered by the power inverter module 102. The DC input power stored in the one or more capacitors 112 is supplied to the inverter 116 and inverted back to AC power at high frequency by one or more transistors 122 within the inverter 116. In some embodiments, the one or more transistors 122 are in the form of insulated gate bipolar transistors (IGBTs). In some embodiments, the switching frequency of the one or more transistors 122 is between about 18 kilohertz (kHz) and about 22 kHz.

The AC power from the inverter 116 is passed through the transformer 118 to lower a voltage of the high-frequency AC power (e.g., a step-down transformer). After the AC power is stepped down via the transformer 118, the AC power is rectified to DC power by a second rectifier of the one or more rectifiers 110 to produce the welding power that is output to the weld gun 106.

When battery input power is supplied to the power inverter module 102, the battery power is supplied directly to the one or more capacitors 112, rather than first being rectified like the single-phase power input. The battery input power is then converted via the inverter 116, the transformer 118, and one of the one or more rectifiers 110 into the welding power supplied to the weld gun 106.

In general, the current sensor 114 is configured to measure an output current of the welding power supplied to the weld gun 106. As described herein, the current sensor 114 is in communication with the control module 104.

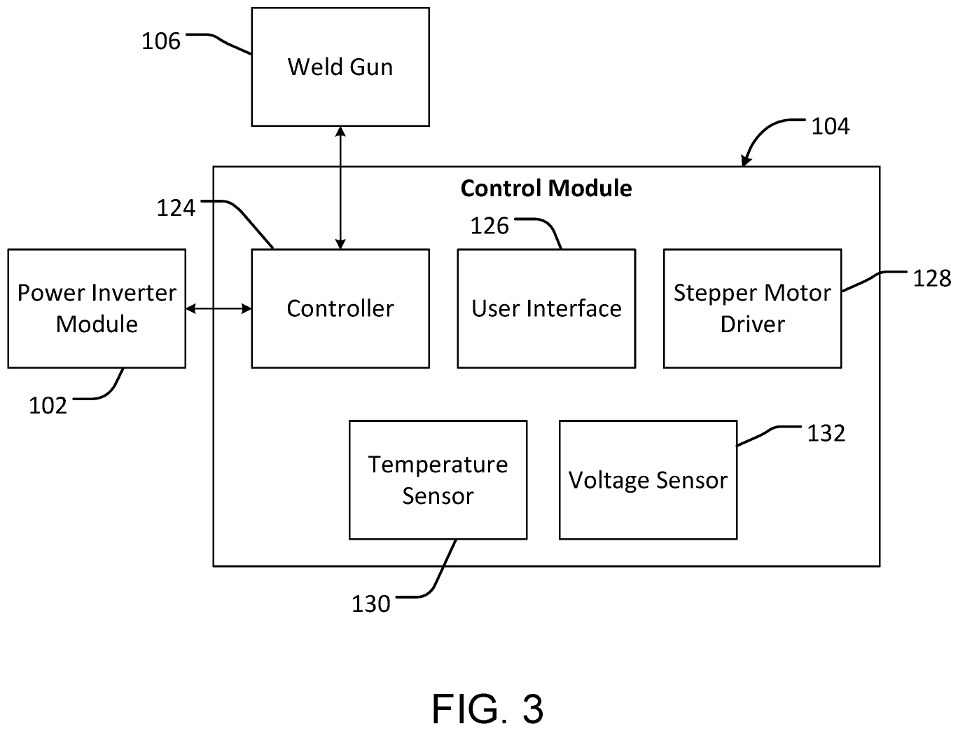

With reference to FIG. 3, the control module 104 includes a controller 124, a user interface or HMI 126, a stepper motor driver 128, a temperature sensor 130, and a voltage sensor 132. The controller 124 is in communication with the power inverter module 102, the weld gun 106, and the components within the control module 104. Specifically, the controller 124 is in communication with the power inverter module 102, the weld gun 106, the user interface 126, the stepper motor driver 128, the temperature sensor 130, and the voltage sensor 132. As described herein, the controller 124 is configured to receive one or more inputs from the user interface 126, monitor the welding power (e.g., output current) supplied to the weld gun 106, and instruct the power inverter module 102 to supply the output current to the weld gun 106 or stop supplying the output current to the weld gun 106.

In some embodiments, the user interface 126 includes a touch screen or display that is configured to receive one or more weld parameters and an output current. In some embodiments, the one or more weld parameters and the output current are input to the user interface 126 by a user based on a particular weld being performed (e.g., stud size, weld distance, etc.). The one or more weld parameters include a lift value, a plunge value, a lift velocity, a plunge velocity, and a weld time. In general, the one or more weld parameters are used to control operation of the weld gun 106 via the stepper motor driver 128 and the output current is the desired output current provided by the welding power output by the power inverter module 102.

As described herein, the stepper motor driver 128 is configured to control a stepper motor of the weld gun 106 to perform a particular weld according to the one or more weld parameters input to the user interface 126. The temperature sensor 130 is configured to measure a temperature of the power inverter module 102 or the control module 104. In some embodiments, the temperature sensor 130 is configured to measure a temperature of a heat sink of the power inverter module 102. The voltage sensor 132 is configured to measure a voltage of one or more components within the power inverter module 102. In some embodiments, the voltage sensor 132 is configured to measure a voltage of the DC bus 120.

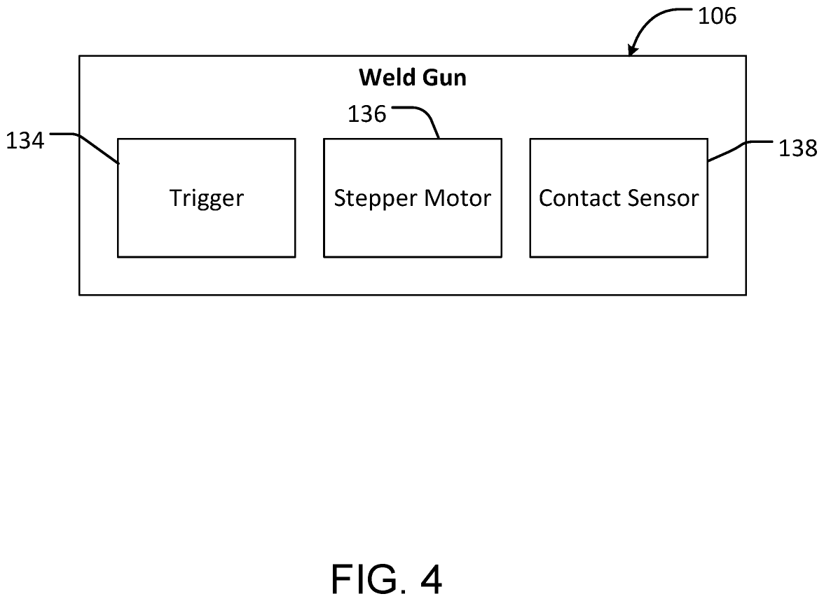

With reference to FIG. 4, the weld gun 106 includes a trigger 134, a stepper motor 136, and a contact sensor 138. The trigger 134 is configured to be activated or actuated, for example, by a user, to initiate a weld performed by the weld gun 106. The stepper motor 136 controls the movement of the weld gun 106 during a weld. For example, the stepper motor 136 controls a lift height, a plunge height, a lift velocity, a plunge velocity, and a weld time base on the respective values input to the user interface 126 when welding a stud to a base material. The integration of the stepper motor 136 into the weld gun 106 provides superior control of the drawn arc welding process performed by the weld gun 106, which improves weld quality and reduces the time required to perform the weld, when compared to a weld gun without a stepper motor.

The contact sensor 138 is configured to detect whether the weld gun 106 is in contact with the base material prior to initiating the weld. For example, the contact sensor 138 is configured to detect if a stud positioned within the weld gun 106 is in contact with the base material by detecting the presence of a contact resistance. In some embodiments, the trigger 134, the stepper motor 136, and the contact sensor 138 are in communication with the controller 124.

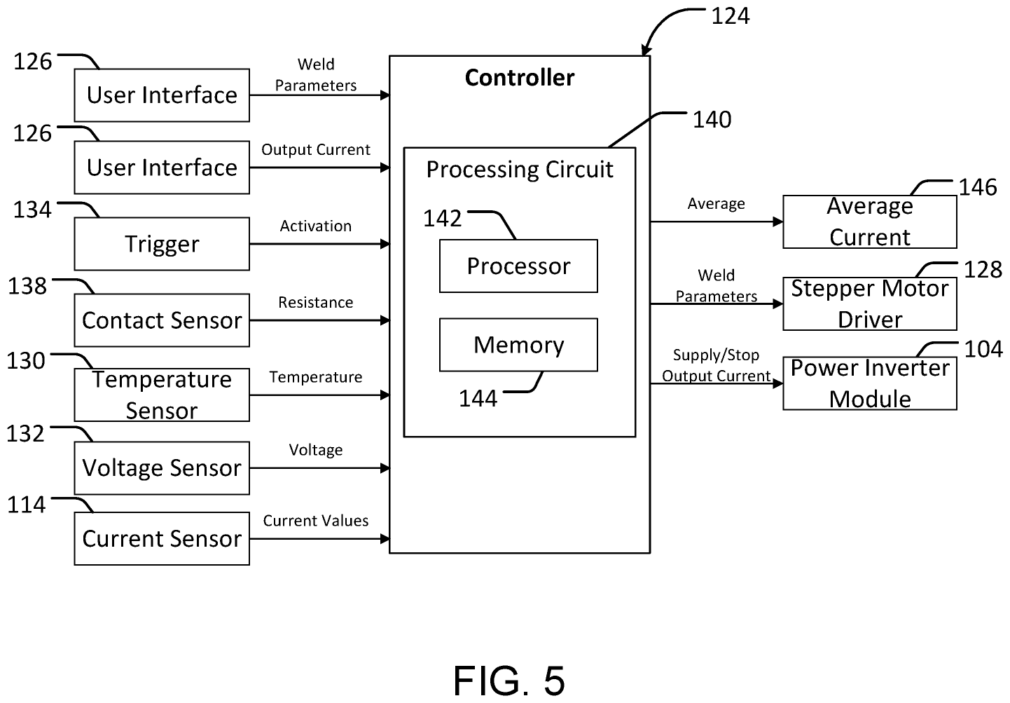

Turning to FIG. 5, the controller 124 includes a processing circuit 140 having a processor 142 and memory 144. The processing circuit 140 can be communicably connected to a communications interface such that the processing circuit 140 and the various components thereof can send and receive data via the communications interface. The processor 142 can be implemented as a general-purpose processor, an application specific integrated circuit (“ASIC”), one or more field programmable gate arrays (“FPGAs”), a group of processing components, or other suitable electronic processing components.

The memory 144 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 144 can be or include volatile memory or non-volatile memory. The memory 144 can include database components, object code components, script components, or any other type of information structure for supporting the various activities and information structures described in the present application. According to some embodiments, the memory 144 is communicably connected to the processor 142 via the processing circuit 140 and includes computer code or instructions for executing (e.g., by the processing circuit 140 and/or the processor 142) one or more processes described herein.

The user interface 126 is in communication with the controller 124 and is configured to communicate the one or more weld parameters and the output current that are input to the user interface 126 to the controller 124. The controller 124 is configured to communicate the one or more weld parameters to the stepper motor driver 128 and the stepper motor driver 128 is configured to control the stepper motor 136 according to the one or more weld parameters to perform a weld.

The trigger 134 and the contact sensor 138 are in communication with the controller 124 and configured to provide input signals to the controller 124 that determine if the controller 124 instructs the power inverter module 102 to supply output current to the weld gun 106. For example, once the trigger 134 is activated, the trigger 134 sends an activation signal to the controller 124. Once the activation signal is detected by the controller 124, the controller 124 determines if the contact resistance between the stud and the base material is detected by the contact sensor 138. If the contact resistance is detected, the controller 124 is configured to instruct the power inverter module 102 to supply the output current (e.g., welding power) to the weld gun 106 and perform a weld. If the contact resistance is not detected by the contact sensor 138, the controller 124 does not instruct the power inverter module 102 to supply the output current to the weld gun 106. In some embodiments, the controller 124 provides an indication (e.g., a light, an audible noise, a visual indication on the user interface 126) that indicates to a user that the contact resistance was not detected by the contact sensor 138.

The temperature sensor 130 and the voltage sensor 132 are in communication with the controller 124 and configured to provide input signals to the controller 124 based on the measured temperature and measure voltage, respectively. In some embodiments, the controller 124 is configured to determine if the temperature measured by the temperature sensor 130 exceeds a temperature threshold. If the temperature measured by the temperature sensor 130 is greater than or equal to the temperature threshold, the controller 124 is configured to shutdown the power inverter module 102 and prevent the power inverter module 102 from supplying welding power. In some embodiments, the controller is configured to determine if the voltage measured by the voltage sensor 132 exceeds a voltage threshold. If the voltage measured by the voltage sensor 132 is greater than or equal to the voltage threshold, the controller 124 is configured to shutdown the power inverter module 102 and prevent the power inverter module 102 from supplying welding power.

The current sensor 114 is in communication with the controller 124 and configured to provide one or more input signals to the controller 124 based on the measured output current provided to the weld gun 106. For example, once a weld is initiated, the current sensor 114 measures the output current supplied by the power inverter module 102 at a predetermined frequency to obtain a plurality of measured current values. The plurality of measured current values are communicated to the controller 124 and the controller 124 is configured average the plurality of measured current values to generate an average measured current value 146. During the weld, the controller 124 is configured to determine if the output current is outside of a current tolerance range. Specifically, the controller 124 is configured to determine if one of the plurality of measured current values is greater than or less than a current tolerance (e.g., about plus or minus 10%) from the average measured current value 146. In other words, the controller 124 is configured to determine if the output current is outside of a current tolerance range during a weld. If one of the measured current values is not within the current tolerance of the average measured current value 146, the controller 124 is configured to stop the power inverter module 102 from supplying the output current to the weld gun 106. In this way, for example, the controller 124 is configured to monitor the output current during a weld and maintain weld quality by stopping a welding process if the output current falls outside of the current tolerance.

The specific value of the output current provided to the weld gun 106 is based on the value for the output current input to the user interface 126. In general, the transistors 122 of the inverter 116 are electrically controlled to vary the characteristics (e.g., output current) of the welding power provided to the weld gun 106. In some embodiments, the controller 124 is in communication with the power inverter module 102 and configured to control the transistors 122 so that the output current that is input to the user interface 126 is supplied by the power inverter module 102 to the weld gun 106. In some embodiments, the power inverter module 102 includes a dedicated controller (e.g., a processing circuit having memory and a processor) that is configured to receive, from the controller 124, the output current that is input to the user interface 126, and the dedicated controller in the power inverter module 102 controls the transistors 122 to provide the output current that is input to the user interface 126 to the weld gun 106.

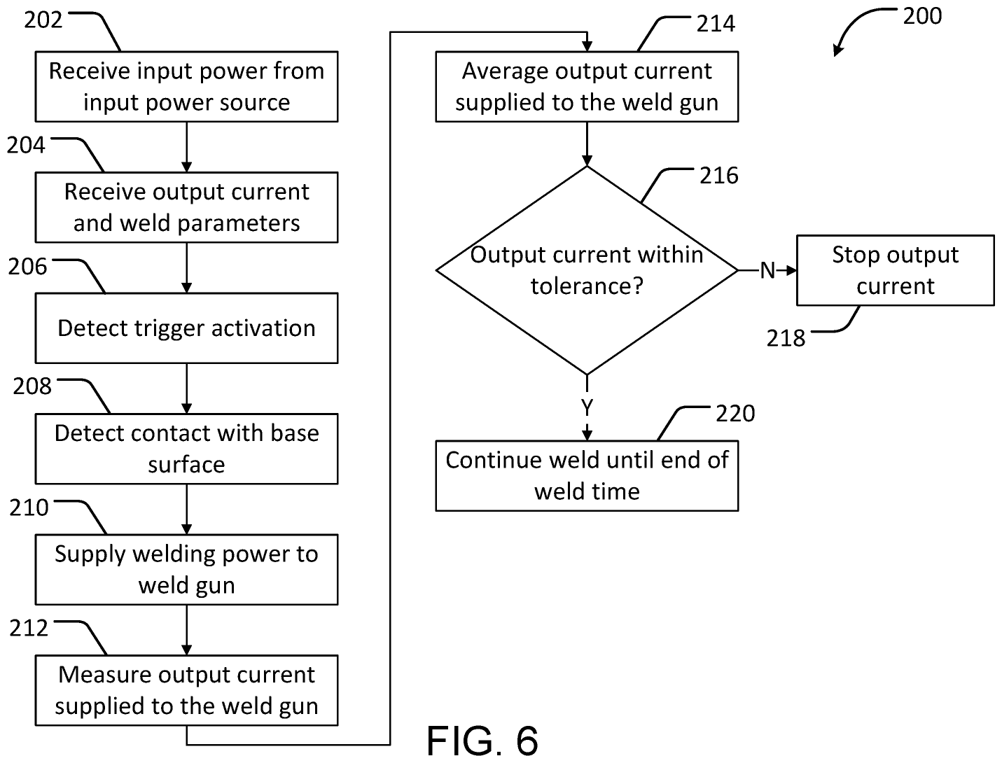

FIG. 6 illustrates a method 200 for operating a drawn arc welding system (e.g., the drawn arc welding system 100. The method initiates at step 202 where the input power is provided to the power inverter module 102 from the input power source 108. In some embodiments, the input power is single-phase input power provided with an input current of less than or equal to 20 A. At step 204, the user interface 126 receives one or more weld parameters and an output current. The one or more weld parameters include a lift value, a plunge value, a lift velocity, a plunge velocity, and a weld time. The output current is a setpoint current that is output by the power inverter module 102 to the weld gun 106 for a particular weld operation.

After receiving the one or more weld parameters and the output current at the user interface 126, the controller 124 detects, at step 206, that the trigger 134 is activated. In response to the trigger 134 being activated, the controller 124 determines, at step 208, if the contact sensor 138 detects that the stud is in contact with the base surface based on the contact resistance measured by the contact sensor 138. If the contact sensor 138 detects that the stud is in contact with the base surface, the controller 124, at step 210, instructs the power inverter module 102 to supply welding power to the weld gun 106. The welding power is provided with an output current that is within a current tolerance of the output current that is input to the user interface 126. In some embodiments, the welding power includes an output current that is less than or equal to about 550 A.

Once the power inverter module 102 supplies the welding power to the weld gun 106, the stepper motor driver 128 is instructed by the controller 124 to control the stepper motor 136 and thereby control movement of the weld gun 106 during a weld. As the power inverter module 102 is supplying the welding power to the weld gun 106, the controller 124, at step 212, receives measurements from the current sensor 114 of the output current supplied by the power inverter module 102 to the weld gun 106. The controller 124 receives measured values for the output current at a predetermined frequency, which results in a plurality of measured current values being provided to the controller 124 during the weld. At step 214, the controller 124 averages the plurality of measured current values to generate an average output current value.

The controller 124 then determines, at step 216, if the output current is within a current tolerance range. For example, the controller 124 determines if a measured current value is greater than or less than (i.e., outside of or not within) a current tolerance (e.g., plus or minus 10%) of the average output current value. If the controller 124 determines that one of the measured current values is not within the current tolerance of the average output current value at step 216, the controller 124 is configured to instruct the power inverter module 102 to stop supplying the output current to the weld gun 106 and stop the weld at step 218. If the controller 124 determines that the measured current values are within the current tolerance of the average output current value at step 216, the power inverter module 102 continues to supply the output current to the weld gun 106 and continue the weld at step 220. The weld continues until a duration of the weld is greater than or equal to the weld time input to the user interface 126.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure Likewise, software implementations of the described methods could be accomplished with standard programming techniques with rule-based logic and other logic to accomplish the various connection steps, processing steps, comparison steps, and decision steps.

It is important to note that the construction and arrangement of the drawn arc welding system 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A drawn arc welding system, comprising:
a weld gun including a stepper motor;
a power inverter module configured to receive a single-phase power input and output welding power to the weld gun, wherein the single-phase power input includes an input current of less than or equal to about 20 A; and
a control module including a stepper motor driver, a user interface, and a controller in communication with the stepper motor driver, the user interface, and the power inverter module, the controller being configured to:
receive a current for the welding power from the user interface; and
instruct the power inverter module to output the current to the weld gun.

2. The drawn arc welding system of claim 1, wherein the current is less than or equal to about 550 A.

3. The drawn arc welding system of claim 1, wherein the power inverter module includes a rectifier and a capacitor.

4. The drawn arc welding system of claim 1, wherein the controller is further configured to stop the power inverter module from outputting the current to the weld gun in response to determining that the current is outside of a current tolerance range.

5. The drawn arc welding system of claim 4, wherein the controller is further configured to measure the current output to the weld gun to obtain a plurality of measured current values.

6. The drawn arc welding system of claim 5, wherein the controller is further configured to average the plurality of measured current values to generate an average measured current value.

7. The drawn arc welding system of claim 6, wherein the controller is further configured to determine that the current is outside of the current tolerance range when one of the plurality of measured current values is greater than or less than a current tolerance from the average measured current value.

8. The drawn arc welding system of claim 1, wherein the user interface is configured to receive one or more weld parameters, and the controller is further configured to send the one or more weld parameters to the stepper motor driver to control the stepper motor according to the one or more weld parameters.

9. The drawn arc welding system of claim 8, wherein the one or more weld parameters include a lift value, a plunge value, a lift velocity, a plunge velocity, and a weld time.

10. A drawn arc welding system, comprising:
a weld gun including a stepper motor and a trigger;
a power inverter module including a rectifier and a capacitor, wherein the power inverter module is configured to receive input power from an input power source, wherein the input power source is a single-phase alternating-current power source or a battery; and
a control module including a stepper motor driver, a user interface, and a controller in communication with the weld gun, the stepper motor driver, the user interface, and the power inverter module, the controller being configured to:
receive an output current from the user interface;
instruct, in response to activation of the trigger, the power inverter module to supply the output current to the weld gun to perform a weld;
monitor, during the weld, the output current supplied by the power inverter module to the weld gun; and
stop the power inverter module from supplying the output current to the weld gun in response to determining that the output current is outside of a current tolerance range.

11. The drawn arc welding system of claim 10, wherein the output current is less than or equal to about 550 A.

12. The drawn arc welding system of claim 10, wherein the controller is further configured to measure the output current to obtain a plurality of measured current values.

13. The drawn arc welding system of claim 12, wherein the controller is further configured to average the plurality of measured current values to generate an average measured current value.

14. The drawn arc welding system of claim 13, wherein the controller is further configured to determine that the output current is outside of the current tolerance range when one of the plurality of measured current values is greater than or less than a current tolerance from the average measured current value.

15. The drawn arc welding system of claim 10, wherein the user interface is configured to receive one or more weld parameters, and the controller is further configured to send the one or more weld parameters to the stepper motor driver to control the stepper motor according to the one or more weld parameters.

16. The drawn arc welding system of claim 15, wherein the one or more weld parameters include a lift value, a plunge value, a lift velocity, a plunge velocity, and a weld time.

17. A method for operating a drawn arc welding system, the method comprising:
receiving, at a power inverter module, single-phase input power with an input current of less than or equal to about 20 A;
detecting a trigger activation from a weld gun;
supplying, from the power inverter module, welding power with an output current of less than or equal to about 550 A to the weld gun;
measuring the output current to collect a plurality of measured current values;
averaging the plurality of measured current values to generate an average output current value; and
stopping the power inverter module from supplying the output current if one of the plurality of measured current values is greater than or less than a current tolerance from the average output current value.

18. The method of claim 17, further comprising:
receiving, at a user interface, the output current.

19. The method of claim 17, further comprising:
receiving, at a user interface, one or more weld parameters; and
controlling a stepper motor of the weld gun to move the weld gun according to the one or more weld parameters.

20. The method of claim 19, wherein the one or more weld parameters include a lift value, a plunge value, a lift velocity, a plunge velocity, and a weld time.
